(19) United States
(12) Patent Application Publication
(10) Pub. No.: US 2023/0294733 A1
(43) Pub. Date: Sep. 21, 2023

(54) SYSTEM AND METHOD FOR MANAGING THE POSITION OF AN AUTONOMOUS VEHICLE

(71) Applicant: RENAULT s.a.s., Boulogne-Billancourt (FR)

(72) Inventors: David GONZALEZ BAUTISTA, Saint Cyr l'Ecole (FR); Imane MAHTOUT, Sarcelles (FR); Vicente MILANES, Boulogne-Billancourt (FR); Francisco Martin NAVAS MATOS, Paris (FR)

(73) Assignee: RENAULT s.a.s., Boulogne-Billancourt (FR)

(21) Appl. No.: 17/773,483

(22) PCT Filed: Oct. 30, 2020
(86) PCT No.: PCT/EP2020/080564

§ 371 Date: Apr. 29, 2022

(30) Foreign Application Priority Data
Oct. 30, 2019 (FR) 19 12223

(51) Int. Cl. B60W 60/00; B60W 50/02

(52) U.S. Cl. CPC B60W 60/0015; B60W 50/0205; B60W 2710/18

(57) ABSTRACT

A method for managing the position of a vehicle includes estimating first positions of the vehicle at various times, measuring second positions of the vehicle at these same various times, in the case of a discrepancy between the first and second positions, considering the first positions as current positions of the vehicle at these various times, incrementing a counter when a discrepancy exists between a first position and a second position at the same time, and when the counter reaches a threshold value, placing the vehicle in a safe mode.

The invention relates to a system for managing the position of an autonomous vehicle. The invention also relates to an autonomous vehicle comprising such a management system. The invention further relates to a method for managing the position of an autonomous vehicle. The invention additionally relates to a warning system, in particular a visual, haptic or sound warning system, for a driver or a remote operator. Lastly, the invention relates to a data synthesis system.

In an autonomous vehicle, a certain number of sensors are commonly provided to improve the performance of the vehicle. A location system is usually provided to locate the vehicle in a local or global reference frame. Algorithms for detecting and tracking the movement of the vehicle, as well as a path planner, are often linked to such a location system. It would therefore be important to provide an accurate location system for an autonomous vehicle.

However, the additional sensors typically used in autonomous vehicles, such as, for example, based on lidar, based on RTK-DGPS or based on INS, are expensive and may experience malfunctions and/or errors. This results in a risk of losing control of the vehicle.

Document JP2004271293 teaches a navigation device and method using location information provided by GPS (Global Positioning System), as well as a location history of the vehicle. GPS data are defined as the current position of the vehicle only if they are within the predicted vehicle position range on the basis of the device's own position data and the position history. Otherwise, the estimated position of the vehicle is set as the current position of the vehicle. Various thresholds are determined for the orientation angle and the distance traveled for various velocity values. The estimated position of the vehicle is calculated from point-based motion equations for a given velocity and orientation angle.

However, this solution has drawbacks. In particular, the state of the vehicle may be predicted only with respect to the current state of the vehicle without taking the controller into account. This solution only makes it possible to predict the state of the vehicle in a single future time interval.

The object of the invention is to provide a system and a method for managing the position of an autonomous vehicle that remedies the above drawbacks and improves the systems and methods known from the prior art. In particular, the invention makes it possible to produce a system and a method that are reliable and that make it possible to dispense with the use of additional sensors and make it possible to dispense, safely, with temporary errors in a location system.

To achieve this objective, the invention relates to a method for managing the position of a vehicle, comprising the following steps:
estimating first positions of the vehicle at various times,
measuring second positions of the vehicle at these same various times,
in the case of a discrepancy between the first and second positions, considering the first positions as current positions of the vehicle at these various times,
incrementing a counter when a discrepancy exists between a first position and a second position at the same time,
when the counter reaches a threshold value, placing the vehicle in a safe mode.

The estimation step may comprise:
combining a longitudinal model and a lateral model of the vehicle in a closed loop so as to calculate subsequent safety states of the vehicle, in particular subsequent positions of the vehicle, and
generating safety states of the vehicle, in particular safety positions of the vehicle.

In the present application, the safety states are preferably future or subsequent safety positions of the vehicle which are calculated and correspond to operating modes which aim to mitigate various cases of deterioration in a positioning system using sensors.

This may be, for example, the classic case of deterioration in satellite positioning when the vehicle passes through a tunnel in which positioning accuracy is negatively affected, going from a centimeter-scale error to an absolute error of 40 centimeters. At the same time, the lane width decreases from 3.5 meters to 2.5 meters just after passing through the tunnel, such that the accuracy, which is normally sufficient for highway scenarios, is not enough to ensure that the vehicle is still following the lane. In this case, the method according to the invention may be implemented in such a way as to increase the accuracy while slowing down the speed profile, so as to allow time for the GPS positioning system to regain its maximum capability. The estimate according to the invention continues to be compared with the real value and, once the centimeter-scale precision of the GPS has been regained, there is a return to the solution based on the sensors, restarting the method and the counter.

Another case of possible deterioration may be when the sensor-based positioning system is completely inoperative, but the vehicle has to continue driving in autonomous mode until a safe stop position is reached. Safety pilot activation is prevented, indicated by a color change in the HMI for example. The length of the remaining path in the navigation system is then considered, in order to create a deceleration profile so as to stop the vehicle at the end of this path; and the invention replaces the positioning system such that lateral errors with respect to the path are calculated by considering the current position of the vehicle at each time. Safety states make it possible to define a smooth deceleration of the vehicle until as much reliable information as possible is available from the navigation system, warning the driver via the HMI, so that they may regain control.

As indicated further below in the document, the first positions of the vehicle are determined from an accuracy ellipse, i.e. by converging a plurality of safety positions. Thus, based on multiple safety states of the vehicle, a first position of the vehicle is determined.

Preferably, what is meant by “longitudinal model” is a mathematical model that makes it possible to determine/estimate a future longitudinal position of a vehicle from a current longitudinal position of the vehicle.

Preferably, what is meant by “transverse model” is a mathematical model that makes it possible to determine/estimate a future transverse position of a vehicle from a current transverse position of the vehicle.

The method may comprise producing a synthesis data system to compensate for single or multiple errors in an automated location system of a location system.

In the present application, synthesis data refer to the positioning or location data generated according to the invention on the basis of a vehicle model, called the complete model, using the lateral and longitudinal controllers in a loop. The model is fed by the navigation system (or location system). This means that the same data are used to feed the vehicle controller (i.e. the controller of the real vehicle) and to feed the vehicle model, such that the next real position of the vehicle corresponds to the next GPS position of the vehicle. The synthesis data have the same structure or substantially the same structure, preferably exactly the same structure, as the data from the positioning system (or location system), that is to say X-Y coordinates and a heading, which is enough to control the vehicle. The synthesis data are the data which define the aforementioned safety states, i.e. each safety state is defined by a set of synthesis data.

A synthesis datum is, for example, a latitude, a longitude, an abscissa, an ordinate or a heading. Each synthesis datum is advantageously provided by an estimated safety position module which will be described below. A set of synthesis data therefore makes it possible to define a safety state of the vehicle.

Regarding the way in which the synthesis data may compensate for errors, it is possible to consider, for example, the same case as above of passing through a tunnel where the accuracy of the satellite positioning system is degraded to an error of 40 cm, which would cause the vehicle to depart from its lane in the absence of the invention. However, with the invention integrating all of the dynamics of the vehicle as well as the control response, while it certainly does not prevent drift of the vehicle in its lane with time, this drift is considerably lower than that of the GPS system: the invention reduces positioning uncertainty and therefore improves performance.

The method may comprise a step of storing safety states of the vehicle, in particular safety positions of the vehicle.

The method may comprise a step of determining an accuracy ellipse obtained from the calculated safety positions.

The estimation step may comprise a step of determining a first, estimated position of the vehicle from the accuracy ellipse, by converging the plurality of calculated safety positions.

The method may comprise a step in which it is deemed that there is a discrepancy by comparing a second position with respect to the accuracy ellipse, in particular if the second position is outside the accuracy ellipse.

The invention also relates to a system for managing the position of a vehicle comprising means for implementing the method defined above.

The system may comprise:
an element for indicating an error in an automated location system; and
an element for activating an emergency braking maneuver in the event of an error in the automated location system.

The invention further relates to a motor vehicle comprising a system as defined above.

The invention also relates to a computer program product comprising program code instructions stored on a computer-readable medium for implementing the steps of the method as described above when said program is run on a computer, or computer program product that is downloadable from a communication network and/or stored on a data medium that is readable by a computer and/or executable by a computer, comprising instructions which, when the program is run by the computer, result in this computer implementing the method as described above.

The invention further relates to a computer-readable data storage medium on which is stored a computer program comprising program code instructions for implementing the method as described above, or to a computer-readable storage medium comprising instructions which, when they are executed by a computer, result in this computer implementing the method as described above.

Lastly, the invention relates to a signal from a data storage medium carrying the computer program product as defined above.

The appended drawings show, by way of example, one embodiment of a position management system according to the invention and one implementation of a position management method according to the invention.

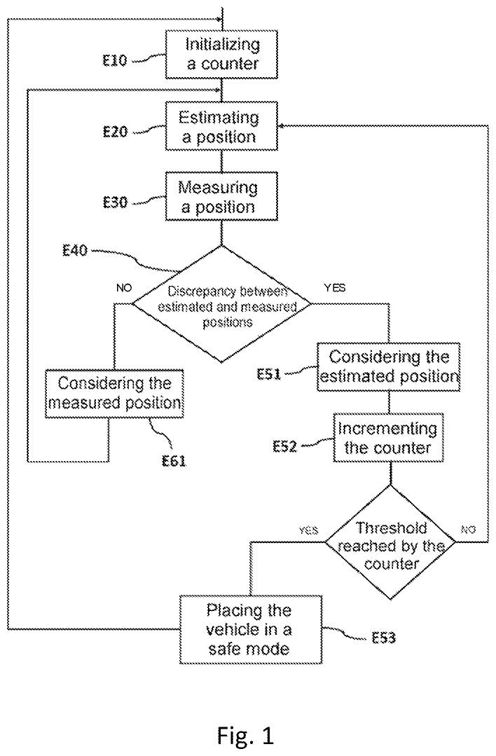

FIG. 1 shows a flowchart of one implementation of a method for managing the position of a vehicle.

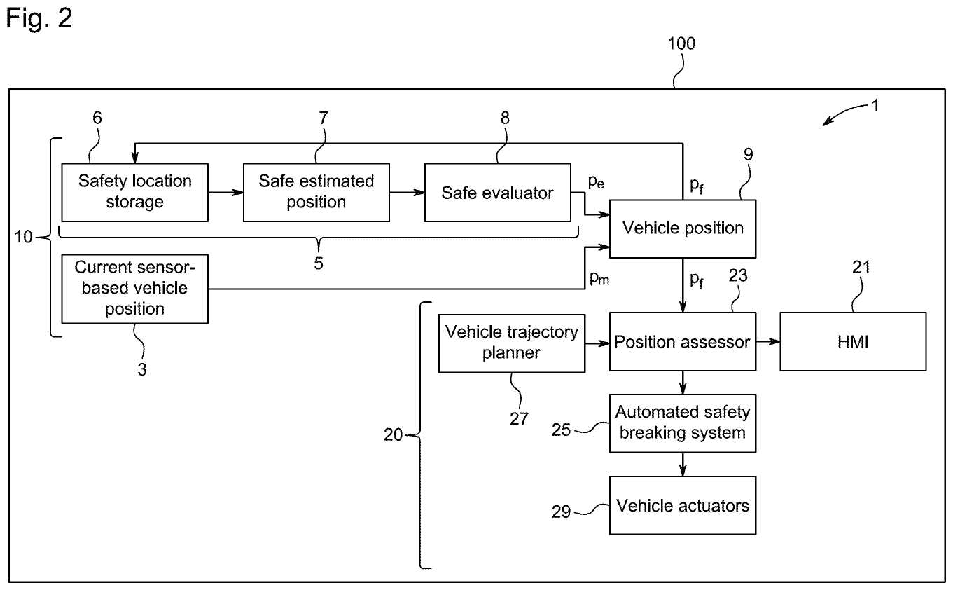

FIG. 2 shows one embodiment of a system for managing the position of an autonomous vehicle.

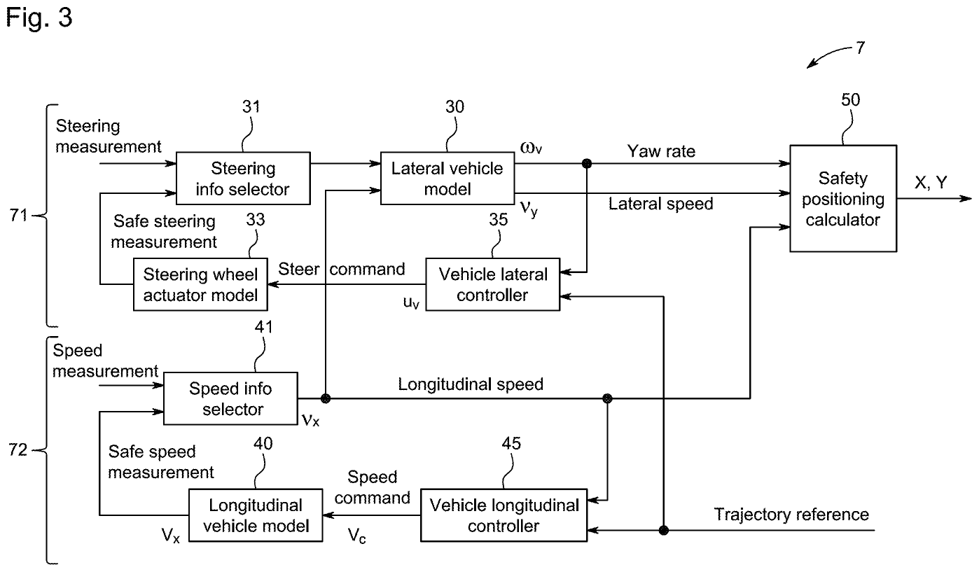

FIG. 3 shows one embodiment of an estimated safety position module of a position management system of the type of FIG. 2.

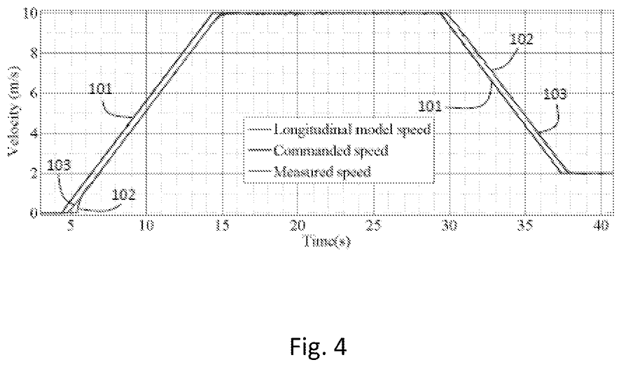

FIG. 4 is a graph illustrating the consideration of the longitudinal response of the vehicle by a longitudinal model of the vehicle of an estimated safety position module of the type of FIG. 3.

The invention provides a system for managing the position of an autonomous vehicle designed to continuously check the output of the system, which makes it possible in particular to evaluate its accuracy.

Initially, a predicted vehicle location datum is calculated with the latest reliable location information available. This prediction is made using a complete model of the vehicle, including the vehicle's internal control logic. The estimated and real data are compared in order to determine whether the new location datum is accurate enough, allowing any potential failure at the frequency of the safety positioning system to be detected. If no failure is detected, the estimated safety datum is presumed to be the correct position of the vehicle.

This results in two main functionalities of such a system for managing the position of a vehicle. A first functionality of the system is that it makes it possible to indicate when the system finds and provides exact location values. A second function of the system is that it makes it possible to determine when the system reaches its limits, and potentially place the vehicle in a safe mode, in particular by activating emergency braking.

The invention provides a system using a complete model of the vehicle and a control algorithm. Such a system is able to estimate subsequent safety positions of the vehicle with a higher frequency than commonly used location systems.

Such a system makes it possible to obtain an envelope ellipse of provisional safety position points in which the next position of the vehicle should be found. Such an ellipse takes into account the current dynamics of the vehicle and the estimated future dynamics of the vehicle.

Such a system for managing the position of a vehicle is able to use all available vehicle information. The complete model of the vehicle and the control algorithm are able to take the latest information available into account in order to estimate the rest of the variables.

The invention provides a method for managing the position of a vehicle, comprising the following steps:
estimating first positions of the vehicle at various times,
measuring second positions of the vehicle at these same various times,
in the case of a discrepancy between the first and second positions, considering the second positions as current positions of the vehicle at these various times,
incrementing a counter when a discrepancy exists between a first position and a second position at the same time,
when the counter reaches a threshold value, placing the vehicle in a safe mode.

One embodiment of the method for managing the position of a vehicle is described below with reference to FIG. 1.

In a first step E10, a counter is initialized at time t.

In a second step E20, a position of the vehicle at this time t, called the first position, is estimated.

In a third step E30, a position of the vehicle at this same time t, called the second position, is measured.

In a fourth step E40, the first, estimated position and the second, measured position are compared.

In the case of a discrepancy between the first, estimated position and the second, measured position, in a step E51, the first, estimated position is considered as the current position of the vehicle at this time t. In a step E52, the counter is incremented. The first, estimated position may consist, as explained below, of a set of positions contained in a geometric figure, in particular an ellipse. It may therefore be deemed that there is a discrepancy between the first, estimated position and the second, measured position if the measured position is outside the geometric figure.

After step E52 of incrementing the counter, if the threshold value is not reached by the counter, the method is reiterated from the second step E20. If the counter reaches the threshold value, in a step E53, the vehicle is placed in a safe mode.

In the case that there is no discrepancy between the first, estimated position and the second, measured position, in a step E61, the second, measured position is considered as the current position of the vehicle at this time t. It may therefore be deemed that there is agreement between the first, estimated position and the second, measured position if the measured position is situated in the geometric figure.

The method is then reiterated from the first step E10, reinitializing the counter.

One embodiment of a system for managing the position of a vehicle comprises:
means 7, 8 for estimating first positions of the vehicle at various times,
means 3 for measuring second positions of the vehicle at these same various times,
comparison and interpretation means 9 which are able to consider, in the case of a discrepancy between the first and second positions, the first positions as current positions of the vehicle at these various times, and able to consider, in the case of agreement between the first and second positions, the second positions as current positions of the vehicle at these various times,
a counter 23 able to increment for as long as there is a discrepancy between a first position and a second position at the same time and able to be initialized in the case of agreement between a first position and a second position at the same time,
means 25, 29 for placing the vehicle in a safe mode when the counter reaches a threshold value.

A short-term error or temporary error is spoken of when the counter has not yet reached said threshold value.

A long-term error or failure is spoken of when the counter reaches said threshold value.

The counter may be a discrepancy occurrence counter or a time counter, in particular a time delay counter. The threshold value may be equal to 0.5 seconds or 5 seconds.

Advantageously, the estimating means 7, 8 comprise:
means 7 for combining a longitudinal model and a lateral model of the vehicle in a closed loop which are able to calculate subsequent safety states of the vehicle, in particular subsequent positions of the vehicle, and
generation means 8 able to generate safety states of the vehicle, in particular safety positions of the vehicle.

The means for placing the vehicle in a safe mode may comprise an emergency braking system 25.

The means 3 for measuring the second positions of the vehicle may comprise at least one position sensor, in particular of GPS type.

The system 1 may further comprise a storage module 6 able to store the safety states of the vehicle, in particular the safety positions of the vehicle.

The system 1 may further comprise a safety evaluator 8 able to provide an accuracy ellipse based on the safety positions calculated by said combining means 7.

Advantageously, the estimating means are able to determine a first, estimated position pₑ of the vehicle from the accuracy ellipse by converging the plurality of safety positions calculated by said combining means 7.

Advantageously, the means for determining the current position of the vehicle 9 are able to consider that there is a discrepancy by comparison with the accuracy ellipse, in particular if the second, measured position is outside the accuracy ellipse.

The system 1 may comprise a device for measuring the steering wheel angle and a device for measuring the angular yaw rate w.

The invention also relates to an autonomous vehicle, in particular an autonomous motor vehicle 100, comprising a system 1 for managing the position of a vehicle of the type described above.

One embodiment of a system 1 for managing the position of an autonomous vehicle 100 is described below with reference to FIG. 2.

The safety positioning system 1 may comprise an automated system for locating the vehicle 3.

The automated system for locating the vehicle 3 comprises, for example, one or more sensors, in particular position sensors, for example of GPS type.

The automated system for locating the vehicle 3 is able to determine the current location or position of the vehicle.

The safety positioning system 1 may comprise two main operating stages 10, 20.

In a first stage 10, the system 1 comprises means for calculating at least one reliable safety position for the vehicle. This makes it possible to ensure a safe location for the autonomous vehicle.

In a second stage 20, the system 1 comprises means for evaluating the position of the vehicle. The second stage 20 of the system 1 makes it possible either to keep the vehicle in autonomous driving mode or to place the vehicle in a safe mode, in particular:
a safe mode in which driving is no longer autonomous but controlled by an occupant of the vehicle through their actions on an interface, and/or
a safe mode in which the system activates an automatic safety braking system in order to reduce the speed of the vehicle and/or to stop the vehicle, and/or
a safe mode in which the system warns a driver or a remote operator by means of a warning system, in particular a visual warning system, indicating that the automated system for locating the vehicle 3 is faulty.

The warning system, instead of being a visual warning system, may be of another type, for example a sound warning system or a haptic warning system.

The interface may include a vehicle steering wheel and/or vehicle speed control pedals.

The second stage 20 of the system 1 may comprise display means 21.

The display means 21 are intended to inform the driver of the vehicle or a remote operator.

The display means 21 may, for example, comprise a human-machine interface, in particular a head-up display.

The display means 21 may, for example, be connected to a remote control center.

The first stage 10 of the system 1 may comprise a module 9 for determining a position of the vehicle.

The second stage 20 of the system 1 may comprise a position evaluator module 23.

The module 9 uses the output of the automated system for locating the vehicle 3 as its main input.

The automated system for locating the vehicle 3 is intended to provide information on the vehicle (X-Y coordinates, position, etc.). For simplicity, the following description focuses on X-Y coordinates, but it may easily be applied to any other variable.

The first stage 10 of the system 1 may further comprise a block 5 for estimating safety positions.

The block 5 is intended to calculate multiple subsequent safety positions of the vehicle based on safety position information previously stored in a storage module 6.

The multiple subsequent safety positions may be calculated in block 5 at a frequency lower than or equal to the maximum frequency of the block 5.

The storage module 6 comprises, for example, the previous positions t-θ of the vehicle, θ being the maximum time horizon in which the system 1 is able to operate.

The estimated safety position module 7 provides p times 8 positions of the vehicle at time t, μ being the difference in frequency between the system 3 and the system 1. The frequency of the system 1 is, for example, of the order of 10 Hz.

The estimated safety positions obtained at the output of the module 7 may be grouped together in a safety evaluator 8.

The function of the safety evaluator 8 is to provide an accuracy ellipse as a function of θ, which makes it possible to converge all of the estimates provided by the module 7 into a single vehicle safety position point.

The module 9 is intended to determine the current position of the vehicle. The current position of the vehicle is in particular intended to be provided to the other automated modules of the vehicle (perception, navigation or control modules).

The current position of the vehicle is chosen in the module 9 according to the position pₘ of the vehicle obtained at the output of the system 3 with respect to the accuracy ellipse calculated in the safety evaluator 8.

If the position pₘ of the vehicle obtained at the output of the system 3 is outside the accuracy ellipse calculated in the safety evaluator 8, the current position pf of the vehicle provided by the module 9 corresponds to the safety position point pₑ calculated in safety evaluator 8.

If the position pₘ of the vehicle obtained at the output of the system 3 is located inside the accuracy ellipse calculated in the safety evaluator 8, the current position pf of the vehicle provided by the module 9 corresponds to the position pₘ of the vehicle obtained at the output of the system 3.

The module 9 delivers the chosen value pf to the position evaluator module 23 of the second stage 20 of the system 1, and to the storage module 6 of the first stage 10 of the system 1 (via feedback).

When the median pₑ generated in the safety evaluator 8 is considered as the current position pf of the vehicle, all of its previous values are also collected in the storage module 6.

All of the data provided by the module 9 may be stored in module 6 until the time horizon θ, with the aim of distinguishing between an isolated failure in the cycle (i.e. minor faults) and longer failures, which makes it possible to determine whether the system 3 provides accurate data or exhibits faults and/or failures during the time horizon θ.

These data are either the latest reliable location data if they are located in the ellipse of points where the vehicle should be situated, or multiple previous predicted safe states of the vehicle if they are located outside the ellipse, i.e. they correspond to a malfunction of the system 1 of the vehicle. This makes it possible to obtain an evaluation of a safety position with respect to the short term and to the long term. This makes it possible to determine the current position of the vehicle and the potential deviation with respect to an exact position. If necessary, these data may be used to place the vehicle in a safe mode, in particular to activate an automatic braking system.

Advantageously, the second stage 20 of the system 1 may comprise an automated safety braking system 25, or emergency braking system, the input of which is connected to the output of the position evaluator module 23.

Advantageously, the position evaluator module 23 of the second stage 20 of the system 1 may comprise a counter.

The counter of the position evaluator module 23 is intended to be triggered as soon as a malfunction is detected in the system 3. This information is obtained from the position pf of the vehicle provided at the output of the module 9.

The counter may be based on a given time or distance horizon, taking into account the position pf of the vehicle provided with acceptable accuracy.

The position evaluator module 23 may provide two possible outputs.

A first output of the module 23 corresponds to the case in which the system 3 again provides accurate data, which stops the counter.

A second output of the module 23 corresponds to the case in which the value supplied by the counter exceeds a given threshold, which activates the automated safety braking system 25.

The second stage 20 of the system 1 may further comprise a vehicle path planner 27.

The output of the path planner 27 may also be provided as the input to the position evaluator module 23.

The second stage 20 of the system 1 may have two functions.

A first function is to signal a malfunction in the system 1 by virtue of a warning signal included in the head-up display or the human-machine interface 21 of the vehicle (or a remote control center).

A second function is the activation of the automated safety braking system 25.

Preferably, the second stage 20 of the system 1 may further comprise actuators 29 connected to the output of the automated safety braking system 25. The actuators 29 are in particular intended to correct the position of the vehicle in the event of temporary errors.

The automated safety braking system 25 may comprise an adaptive control algorithm. Such an adaptive control algorithm makes it possible to perform a smooth braking maneuver as a function of the latest reliable path obtained at the output of the vehicle path planner 27.

The second stage 20 of the system 1 makes it possible to maximize the distance traveled without danger or in complete safety in a degraded state. This makes it possible to minimize the longitudinal deceleration of the vehicle. This results in increased passenger comfort when placing the vehicle in a safe mode.

The first, warning function and the second, braking function of the second stage 20 of the system 1 each contribute to progressively warning the driver or a remote operator and to stopping the vehicle if necessary.

One advantage of a system for managing the position of a vehicle of the type described above is that the state of the vehicle may be predicted in the short term and in the long term, which makes it possible to take an appropriate decision, for example to wait for the system 3 to operate again or place the vehicle in a safety position.

One embodiment of an estimated safety position module 7 of a system 1 for managing the position of a vehicle of the type of FIG. 2 is described in more detail below with reference to FIG. 3.

The estimated safety position module 7 uses a complete model of the vehicle and a control system to determine the safety positions based on known previous positions.

The invention proposes an estimated safety position module 7 using a combined longitudinal model and lateral model of the vehicle, the longitudinal and lateral models being associated with a longitudinal and lateral controller, respectively, in order to generate multiple vehicle safety positions based on information stored in the module 6.

For this, the module 7 may comprise means for combining a longitudinal model and a lateral model of the vehicle in a closed loop so as to calculate subsequent safety states of the vehicle, in particular subsequent safety positions of the vehicle.

Advantageously, the module 7 may comprise a lateral block 71 comprising a lateral model 30 of the vehicle and a longitudinal block 72 comprising a longitudinal model 40 of the vehicle.

The lateral block 71 of the module 7 comprising the lateral model 30 of the vehicle is described below.

The lateral block 71 of the module 7 may comprise a steering wheel angle information selector 31.

The lateral model 30 of the vehicle is intended to receive a steering wheel angle measurement value provided by the selector 31 as input.

The lateral block 71 of the module 7 may further comprise a steering wheel actuator model 33.

The selector 31 is intended to check, at the frequency of the estimated safety position module 7, whether a new steering wheel angle measurement is available. If not, the value generated by the steering wheel actuator model 33 is used as the input to the lateral model 30 of the vehicle as the steering wheel angle measurement.

The frequency of the estimated safety position module 7 is, for example, of the order of 100 Hz.

The lateral model 30 of the vehicle is in particular intended to provide a measured angular yaw rate value ωᵥ.

For this, the following equations may be used:

\dot{X}=AᵥXᵥ+Bᵥuᵥ [Math 1]

Yᵥ=CᵥXᵥ [Math 2]

with:
uᵥ the steering wheel angle control.

The state vector is:

Xᵥ=[Yᵥv_{y}ψᵥωᵥ]^{T} [Math 3]

with:
yᵥ the lateral position of the vehicle,
v_{y} the lateral velocity,
ψᵥ the yaw angle,
ωᵥ angular yaw rate.

The matrices Aᵥ, Bᵥ and Cᵥ of the system are described below:

$${A}_{v} = [ \begin{matrix}0 & 1 & 0 & 0 \\ 0 & \frac{- ( {C}_{f} + {C}_{r} )}{{mv}_{x}} & 0 & \frac{- {aC}_{f} + {bC}_{r}}{{mv}_{x}} - {v}_{x} \\ 0 & 0 & 0 & 1 \\ 0 & \frac{- {aC}_{f} + {bC}_{r}}{{I}_{z} {v}_{x}} & 0 & \frac{- ( {a}^{2} {C}_{f} + {b}^{2} {C}_{r} )}{{I}_{z} {v}_{x}}\end{matrix} ] \qquad [ Math 4 ]$$

$${B}_{v} = {[ \begin{matrix}0 & \frac{{C}_{f}}{m} & 0 & \frac{{aC}_{f}}{{I}_{z}}\end{matrix} ]}^{T} \qquad [ Math 5 ]$$

$${C}_{v} = [ \begin{matrix}0 & 1 & 0 & 0 \\ 0 & 0 & 0 & 1\end{matrix} ] \qquad [ Math 6 ]$$

with:
C_{f} and Cᵣ the cornering stiffness in the front and rear wheel, respectively,
vₓ the velocity of the vehicle,
m the mass of the vehicle,
I_{z} the moment of inertia,
a and b the distance between the center of gravity of the vehicle and the front and rear wheel, respectively.

As input, the lateral model 30 uses the steering wheel angle measurement on the one hand and the longitudinal velocity obtained from the longitudinal model 40 on the other hand.

The lateral velocity v_{y} and the angular yaw rate w, are obtained at the output of the lateral model 30.

These two data output from the lateral model 30, lateral velocity v_{y} and angular yaw rate ωᵥ, are used to calculate the subsequent positions of the vehicle in a safety position computer 50.

The lateral block 71 of the module 7 may further comprise a lateral controller 35 for autonomous vehicles.

The operation of such a lateral controller 35 may be based on minimization of the angular yaw rate w, between the current path of the vehicle and the desired path of the vehicle. The desired path may be calculated based on the data from a camera (or any other sensor) in order to generate a set of waypoints.

The lateral controller 35 is intended to receive as input the angular yaw rate ωᵥ provided by the lateral model 30 on the one hand, and an angular yaw rate provided by another model of the vehicle (corresponding to a reference path). The lateral controller 35 is intended to compare these two angular yaw rate values that correspond, respectively, to the desired path and to the reference path.

This makes it possible to regulate the performance of the lateral controller 35, in particular according to the following equation:

Δuᵥ=k_{gain}(W_{vsouhaité}−ω_{vmesuré}) [Math 7]

with:
k_{gain} in a parameter, dependent on the velocity, that makes it possible to obtain good tracking performance for the desired path.

The steering wheel angle control uᵥ obtained at the output of the lateral controller 35 is provided as input to the steering wheel actuator model 33.

A lateral overall system or block 71 is thus obtained, comprising the vehicle lateral model 30, the vehicle lateral controller 35 and the steering wheel actuator model 33.

One advantage of such a lateral block 71 comprising a lateral model 30 of the vehicle is related to the fact that it takes various limitations into account, which makes it possible to obtain a realistic model. The vehicle lateral controller 35 and the steering wheel actuator model 33 play a key role since the vehicle lateral model 30 alone provides overly optimistic results with respect to actual road performance.

The longitudinal block 72 of the module 7 comprising the longitudinal model 40 of the vehicle is described below.

The longitudinal block 72 of the module 7 may comprise a velocity information selector 41.

The longitudinal block 72 of the module 7 may further comprise a longitudinal controller 45 for autonomous vehicles.

The longitudinal model 40 of the vehicle is intended to receive as input a velocity control command provided by the longitudinal controller 45 of the vehicle.

The operation of the longitudinal controller 45 of the vehicle may be based on minimization of the velocity error between the longitudinal velocity vₓ provided by the velocity information selector 41 and the desired velocity on the reference path.

The longitudinal velocity value vₓ, used in the longitudinal controller 45 of the vehicle, in the lateral model 30 of the vehicle and in the safety position computer 50, may be provided by the velocity information selector 41.

One function of the velocity information selector 41 is to check, at the frequency of the estimated safety position module 7, whether a new longitudinal velocity measurement is available. If not, the measured safety velocity value generated by the longitudinal model 40 of the vehicle is used.

The longitudinal model 40 of the vehicle is intended to provide a safety velocity measurement Vₓ as output.

The longitudinal model 40 of the vehicle may be described by a second-order transfer function linking the velocity control command V_{c}(s) to the velocity measurement Vₓ(s):

$$\frac{{V}_{x} ( s )}{{V}_{c} ( s )} = \frac{{\overline{ω}}_{n}^{2}}{{s}^{2} + 2 ζ {\overline{ω}}_{n} s + {\overline{ω}}_{n}^{2}} \qquad [ Math 8 ]$$

with:
ωₙ the natural frequency in rad/s, ζ the damping factor.

These values depend in particular on the design of the low-level controller, throttling and brake pedal offsets.

One advantage of a longitudinal model 40 of the vehicle of the type described above is that it makes it possible to account for the longitudinal response of the vehicle in an optimal manner.

FIG. 4 allows the comparison of a given velocity control command profile V_{c} (curve 101), the velocity measured by an on-board sensor (curve 102) and the velocity Vₓ obtained from the vehicle longitudinal model 40 (curve 103). As is clearly visible in FIG. 4, the longitudinal model 40 perfectly follows the actual response of the vehicle.

Once the angular yaw rate ωᵥ and the lateral velocity v_{y} have been obtained from the lateral block 71 and the longitudinal velocity vₓ has been obtained from the longitudinal block 72, these values are used as inputs to the safety position computer 50.

The safety position computer 50 makes it possible to obtain the derivatives X, Y of the safety position coordinates, in particular using the general equations of motion below:

[Math 9]

\dot{X}=vₓ cos(ψᵥ)−v_{y} sin(ψᵥ)

\dot{Y}=vₓ sin(ψᵥ)+v_{y} cos(ψᵥ) [Math 9]

The safety position coordinates X, Y are obtained by integrating their respective derivatives \dot{X}, \dot{Y}.

The values X, Y obtained at the output of the safety position computer 50 are the outputs of the estimated safety position module 7.

From the last reliable position, the module 7 estimates the next position at its frequency, updating the available data (path or velocity, or steering wheel angle measurements) between two consecutive position points. A set of X, Y positions is thus obtained which are then transmitted to the safety evaluator 8 in order to obtain the ellipse in which the vehicle should be situated and its median.

The output of the safety evaluator 8 is checked against the current position of the vehicle obtained from the system 3, thereby determining the quality of the current position of the vehicle obtained from the system 3 and providing the final position pf of the vehicle at this time. The output of the module 9 is used as the new position of the vehicle which is returned (by feedback) to the safety position storage module 6 either as a single point (in the case that the current position of the vehicle obtained from the system 3 is reliable) or as a point cloud (when the system 3 provides more than one erroneous position value).

One advantage of a system 1 of the type described above is that it makes it possible to predict the state of the vehicle while taking account of a dynamic model of the vehicle and of a controller in a future time horizon. As a result, the movement of the vehicle may be predicted while taking the action of the controller in the future into account. This improves the lateral response of the vehicle by suppressing the oscillations of the system 1.

Another advantage of a system 1 of the type described above is that it makes it possible to maximize the safety of the autonomous vehicle while dispensing with the use of autonomous driving sensors.

Another advantage of a system 1 of the type described above is that it makes it possible to estimate the future position of the vehicle with greater accuracy. Such a system 1 is able to estimate subsequent safety positions of the vehicle with a frequency of up to 100 Hz, that is to say significantly higher than the frequency of commonly used location systems.

Such a system 1 operates in a short-term and long-term horizon in order to identify temporary faults (i.e. short periods of error) or failures (i.e. long periods of error) in the automated system for locating the vehicle 3, in order to correct these errors or to take actions to place the vehicle in a safe mode, in particular automatic safety braking maneuvers in the event of a failure.

A short-term error or temporary error is spoken of when the counter has not yet reached said threshold value.

A long-term error or failure is spoken of when the counter reaches said threshold value.

The system 1 may comprise means for correcting the position of the vehicle in the event of temporary errors.

The system 1 may comprise a warning system, in particular a visual, haptic or sound warning system, for a driver or a remote operator in order to indicate a long-term error or failure and to activate an emergency braking maneuver. The warning system, in particular a visual, haptic or sound warning system, may comprise an indicator which may be installed in the display means 21.

Although the invention has been described in the case of an autonomous automobile, the invention obviously applies to any type of autonomous vehicle, for example buses or trucks.

1-12. (canceled)

13. A method for managing a position of a vehicle, comprising:
estimating first positions of the vehicle at various times,
measuring second positions of the vehicle at the various times,
when there is a discrepancy between the first and second positions, considering the first positions as current positions of the vehicle at the various times,
incrementing a counter when a discrepancy exists between the first position and the second position at a same time, and
when the counter reaches a threshold value, placing the vehicle in a safe mode.

14. The method as claimed in claim 13, wherein the estimating comprises:
combining a longitudinal model and a lateral model of the vehicle in a closed loop so as to calculate subsequent safety states of the vehicle, and
generating safety states of the vehicle.

15. The method as claimed in claim 14, further comprising:
storing the safety states of the vehicle.

16. The method as claimed in claim 13, further comprising:
producing a synthesis data system to compensate for single or multiple errors in an automated location system of a location system.

17. The method as claimed in claim 13, wherein the estimating comprises:
combining a longitudinal model and a lateral model of the vehicle in a closed loop so as to calculate subsequent positions of the vehicle, and
generating safety positions of the vehicle.

18. The method as claimed in claim 17, further comprising:
storing the safety positions of the vehicle.

19. The method as claimed in claim 17, further comprising:
determining an accuracy ellipse obtained from the safety positions.

20. The method as claimed in claim 19, wherein the estimating comprises determining a first, estimated position of the vehicle from the accuracy ellipse, by converging the safety positions.

21. The method as claimed in claim 20, further comprising:
comparing a second position with respect to the accuracy ellipse, and
determining that there is a discrepancy when the second position is outside the accuracy ellipse.

22. A system for managing the position of a vehicle comprising:
means for implementing the method as claimed in claim 13.

23. The system as claimed in claim 22, the system comprising:
an element configured to indicate an error in an automated location system; and
an element configured to activate an emergency braking maneuver when there is an error in the automated location system.

24. A motor vehicle, comprising:
the system as claimed in claim 22.

25. A non-transitory computer data storage medium on which is stored a computer program that, when executed by a computer, causes the computer to execute the method as claimed in claim 13.
